(19) United States
(12) Patent Application Publication
(10) Pub. No.: US 2016/0263527 A1
(43) Pub. Date: Sep. 15, 2016

(54) Water-saving Type Household Reverse Osmosis (RO) Membrane Assembly

(71) Applicant: KORTECH ENVIRONMENT EQUIPMENT CO., LTD, Shanghai (CN)

(72) Inventor: Jesung PARK, Shanghai (CN)

(21) Appl. No.: 14/772,325

(22) PCT Filed: Apr. 14, 2015
(86) PCT No.: PCT/CN2015/076501

§ 371 Date: Sep. 2, 2015

(30) Foreign Application Priority Data
Jul. 14, 2014 (CN) 201410334438.3

(51) Int. Cl. B01D 61/08; B01D 61/02; C02F 1/44

(52) U.S. Cl. CPC B01D 61/08; C02F 1/441; B01D 61/022; C02F 2307/12; B01D 2317/02; B01D 2313/13

(57) ABSTRACT

A water saving type household reverse osmosis (RO) membrane assembly belongs to the technical field of household purified water and resolves the problem of wasting water resources. The assembly includes a shell, and at least two RO membrane components. The RO membrane components are used by a way of series connection in a proper order, nesting or a combination of series connection and nesting. In two adjacent RO membrane components, a waste water discharge outlet of one of the RO membrane components connects with a water inlet of another RO membrane component, and clean water discharge outlets for all RO membrane components are connected to a clean water pipe. The water-saving type household reverse osmosis membrane assembly provided is rational in design, simple in structure, convenient for production, and reduces cost with a high water recovery rate.

### CROSS REFERENCE OF RELATED APPLICATION

This is a U.S. National Stage under 35 U.S.C 371 of the International Application PCT/CN2015/076501, filed Apr. 14, 2015, which claims priority under 35 U.S.C. 119(a-d) to CN 201410334438.3, filed Jul. 14, 2014.

### BACKGROUND OF THE PRESENT INVENTION

1. Field of Invention

The present invention relates to a household water-filtering equipment and more specifically to a water-saving type household reverse osmosis membrane assembly installed in a household pure water machine membrane shell.

2. Description of Related Arts

With the rapid development of national industrialization, water source pollution has become a major problem for urgent resolution in the country. The pursuit of nationals for a healthy life and the increasing deterioration of drinking water for living constitute a sharp conflict. To resolve the present drinking water condition, reverse osmosis (RO) pure water machine is popular with users. However, in the existing technology, the household reverse osmosis system has such a significant disadvantage as the machine discharging a lot of waste water during producing pure water. For traditional design scheme, the proportion between the pure water flow and waste water flow is around 1:3 when the equipment is producing water, that is, to obtain every liter of pure water, 4 liters of tap water will be consumed. As a result, the water utilization rate is low and a lot of water resources are wasted. This contravenes the concept of saving water resources, sustainable development, low carbon and environmental protection promoted greatly by our country currently.

The existing household reverse osmosis system is also under way of constant technical innovation. However, the water-saving method adopted by the current household reverse osmosis membrane system is achieved by such a process as utilizing waste water backflow, waste water blockage for intermittent centralized discharge. The defects of this water-saving technology as reflected in practical use are as follows: firstly, the practice of waste water backflow is to have the concentrated water flowing out of the waste water proportioner return to the front end of the RO membrane again, so that the TDS value in the tap water rises gradually. When the salts hard to dissolve in water get concentrated constantly in the membrane components to such an extent that exceeds the solubility limit, scale will form on the reverse osmosis membrane surface. The higher the recovery rate is, the higher the risk of scaling will be; secondly, such method as blocking the waste water regularly via solenoid valve and discharging the waste water in a centralized manner produces only pure water during blockage. As a result, the pressure in the RO membrane cavity will rise constantly in the period of blockage, the RO membrane keeps on working in a state of high pressure which even exceeds the RO membrane pressure threshold and the RO membrane service life reduces substantially. Thirdly, controlling waste water discharge via solenoid valve may result in household RO system collapsing directly due to the operation times of solenoid valve exceeding the upper limit or spare parts ageing.

### SUMMARY OF THE PRESENT INVENTION

For the deficiencies present in the above existing technology, the present invention provides a water-saving type household reverse osmosis (RO) membrane assembly, which is rational in design with a high water recovery rate.

To achieve the above goal, the present invention adopts the following technical scheme:

A water-saving type household reverse osmosis (RO) membrane assembly comprises a shell, and at least two RO membrane components. The two RO membrane components are used by a way of series connection in a proper order, nesting or a combination of series connection and nesting. In two adjacent RO membrane components, a waste water discharge outlet of one of the RO membrane components connects with a water inlet of another RO membrane component, and clean water discharge outlets for all RO membrane components are connected to a clean water pipe.

The RO membrane components are separated by a baffle plate therebetween.

The shell comprises a shell cylinder body and a shell end cover.

The shell cylinder body and the shell end cover are sealed by a seal ring, bonded by glue or welded ultrasonically.

The shell comprises the water inlet, one waste water opening and at least one waste water opening.

Each of the RO membrane components comprises a RO membrane layer, wherein the RO membrane layer forms an annular cylinder to filter and divide tap water entering from one end into pure water and waste water for outputting toward the other end; and an intermediate pipe, wherein the intermediate pipe is provided axially in the annular cylinder and has an intermediate passageway internally. The intermediate pipe has a pure water inlet communicating with the intermediate passageway formed on a pipe wall to receive the pure water separated out by the RO membrane layer. An axial length of the intermediate pipe is greater than that of the RO membrane layer.

In comparison with the existing technology, the present invention has the following beneficial effects:

1. Rational in design, simple in structure, convenient for production and reduce cost;

2. High water recovery rate, less waste water discharge to reduce wasting of water resources and the social benefits are huge;

3. Increased service life, safe and reliable during work and better stability.

### BRIEF DESCRIPTION OF THE DRAWINGS

FIG. 1 is the schematic diagram of an appearance of an embodiment 1 provided by the present invention;

FIG. 2 is an A-A sectional view of the FIG. 1;

FIG. 3 is a sectional view of an embodiment 2 provided by the present invention;

FIG. 4 is a sectional view of an embodiment 3 provided by the present invention.

In the FIGS: 100—RO membrane assembly, 1−Shell, 101—Shell cylinder body, 102—Shell end cover, 2—RO membrane components, 20—The first RO membrane component, 201a—The first RO membrane layer, 201b—The first intermediate pipe, 201c—The first intermediate passageway, 202—The second RO membrane component, 202a—The second RO membrane layer, 202b—The second intermediate pipe, 202c—The second intermediate passageway, 203—The third RO membrane components, 203a—The third RO membrane layer, 203b—The third intermediate pipe, 203c—The third intermediate passageway, 3—Water inlet and outlet assembly, 31—Water inlet, 311—The first tap water passageway, 32—Pure water outlet, 32a—The first pure water outlet, 32b—The second pure water outlet, 32c—The third pure water outlet, 321—The first pure water passageway, 322—The second pure water passageway, 323—The third pure water passageway, 33—Waste water outlet, 331—The first waste water passageway, 332—The second waste water passageway, 333—The third waste water passageway, 4—Baffle plate, 401—The first waste water through hole, 402—The second waste water through hole

### DETAILED DESCRIPTION OF THE PREFERRED EMBODIMENT

A detailed description is given to the technical scheme of the present invention in combination with the specification FIGS. and specific embodiments.

A water-saving type household reverse osmosis membrane assembly provided by the present invention comprises a shell 1, and at least two RO membrane components 2. The RO membrane components are used by a way of series connection in proper order, nesting or a combination of series connection and nesting. In two adjacent RO membrane components, a waste water discharge outlet of one of the RO membrane components connects with a water inlet of another RO membrane component, and clean water discharge outlets for all RO membrane components are connected to a clean water pipe.

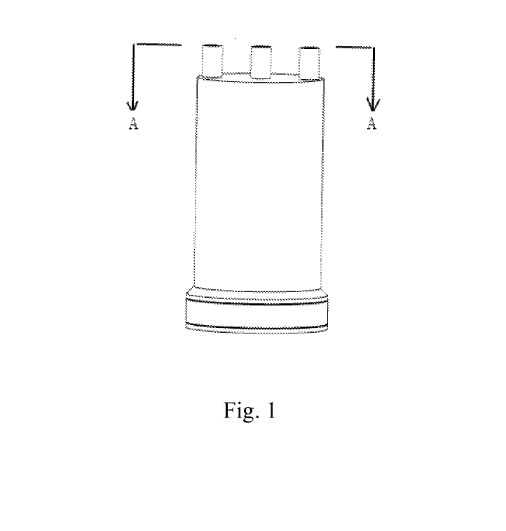

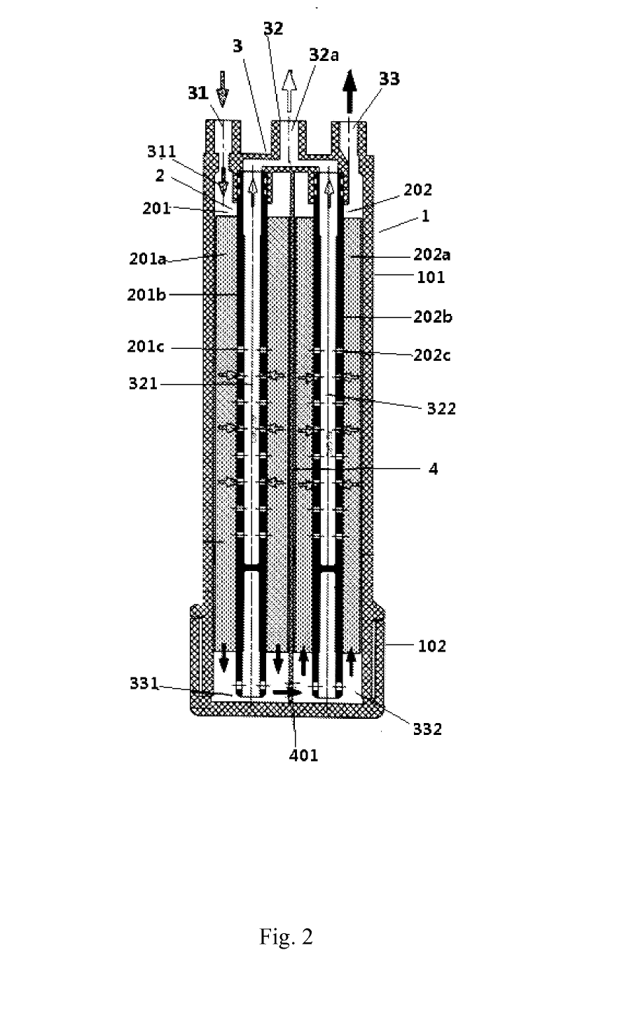

As shown in FIG. 1-FIG. 2, an embodiment 1 provided by the present invention has a RO membrane assembly formed by two RO membrane components 2 in series, including a first RO membrane component 201 and a second RO membrane component 202. Accordingly, a waste water discharge outlet of the first RO membrane component 201 connects with a water inlet of the second RO membrane component 202. The first RO membrane component 201 and the second RO membrane component 202 are separated by a baffle plate 4 therebetween.

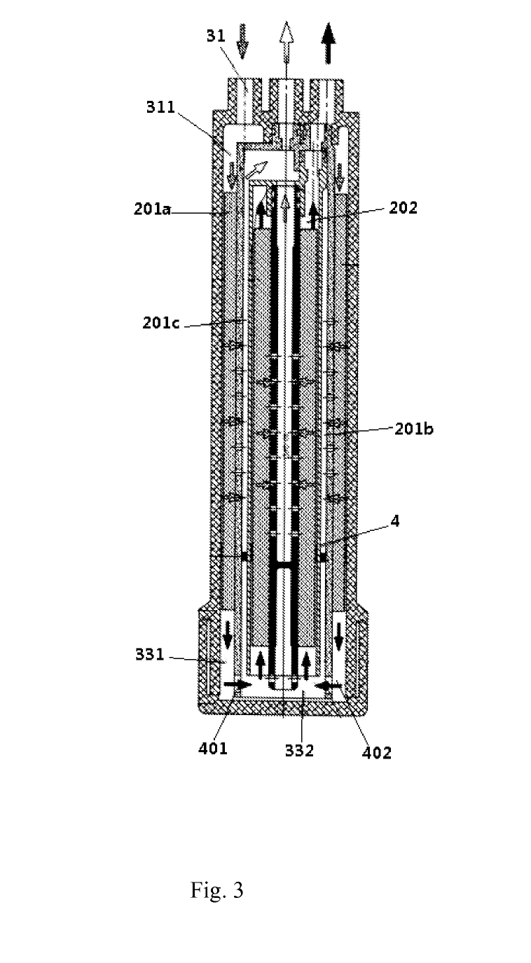

As shown in FIG. 3, an embodiment 2 provided by the present invention has a RO membrane assembly formed by two RO membrane components 2 through nesting, including a first RO membrane component 201 and a second RO membrane component 202. Accordingly, a waste water discharge outlet of the first RO membrane component 201 connects with a water inlet of the second RO membrane component 202. The first RO membrane component 201 and the second RO membrane component 202 are separated by a baffle plate 4 therebetween.

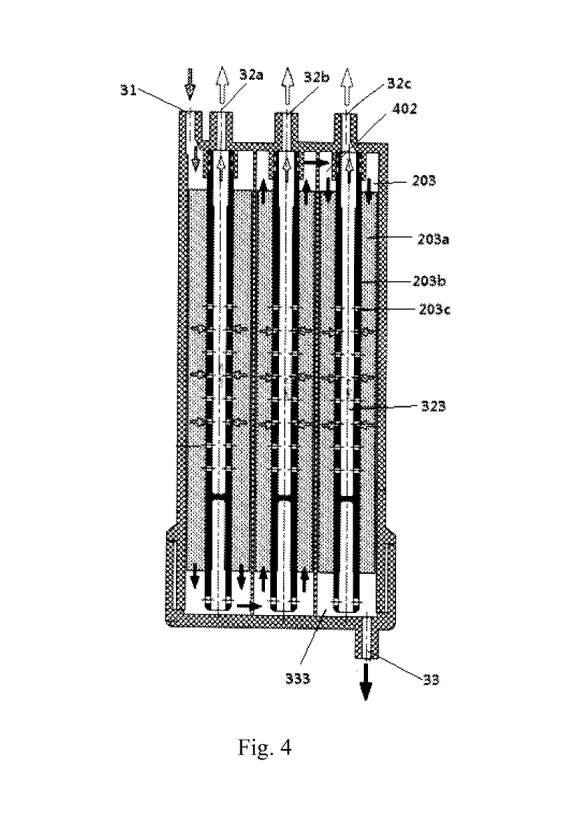

As shown in FIG. 4, an embodiment 3 provided by the present invention has a RO membrane assembly formed by three RO membrane components 2 in series, including a first RO membrane component 201 and a second RO membrane component 202. Accordingly, a waste water discharge outlet of the first RO membrane component 201 connects with a water inlet of the second RO membrane component 202. A filtered waste water discharge outlet connects with a water inlet of a third RO membrane component. The three RO membrane components are used in series to increase a water recovery rate.

Specifically, take the embodiment 3 as shown in the FIG. 4 as an example to explain. The reserve osmosis (OR) membrane assembly 100 of the present invention comprises a shell 1, RO membrane components 2 and a water inlet and outlet assembly 3; the shell 1 comprises a shell cylinder body 101 and a shell end cover 102; the RO membrane components 2 comprise the first RO membrane component 201, the second RO membrane component 202 and the third RO membrane component 230. The first RO membrane component 201 comprises a first RO membrane layer 201a, a first intermediate pipe 201b and a first intermediate passageway 201c. The second RO membrane component 202 comprises a second RO membrane layer 202a, a second intermediate pipe 202b and a second intermediate passageway 202c. The third RO membrane component 203 comprises a third RO membrane layer 203a, a third intermediate pipe 203b and a third intermediate passageway 203c. The water inlet and outlet assembly comprises a water inlet 31, a pure water outlet 32 and a waste water outlet 33.

When working, take the embodiment 1 as shown in the FIG. 2 as an example to explain. Tap water enters from the water inlet 31 into a first tap water passageway 311 and then enters into the RO membrane assembly 2 from the tap water passageway 311. The first RO membrane layer 201a filters and separates the tap water flowing in it into pure water and waste water. The pure water gathers through the first intermediate pipe passageway 201c and enters into the first intermediate pipe 201b and flows toward the pure water outlet 32. At the same time, the waste water separated out enters into a first waste water passageway 331 and then flows into a second waste water passageway 332 through a first waste water through hole 401. The waste water flows past the second RO membrane component 202 again. By flowing into the second RO membrane layer 202a, the waste water is separated again. Part of pure water enters into the second intermediate pipe 202b through the second intermediate pipe passageway 202c and then flows towards the pure water outlet 32. Part of waste water is discharged out directly from the waste water outlet 33.

There is one pure water outlet in the embodiment 1 and there may be multiple ones for other embodiments. In the embodiment 3 as shown in the FIG. 4, the first pure water outlet 32a, the second pure water outlet 32b and the third pure water outlet 32c are provided. At the same time, a first pure water passageway 321, a second pure water passageway 322, a third pure water passageway 323, the first waste water passageway 331, the second waste water passageway 332, a third waste water passageway 333, the first waste water through hole 401 and a second waste water through hole 402 are provided in a supporting manner The principle is the same as that in the embodiment 1 and no explanation is made here in detailed.

The above embodiments should be comprehended as being used only to describe the present invention and not to limit the protection scope of the present invention. Any technical people in the present field can utilize the contents disclosed above to make possible variations and modifications to the scheme lodged by the present invention without being divorced from the spirit and scope of the present invention. Therefore, any simple modification, equivalent change and decoration made according to the technical essence of the present invention to the above embodiments without being divorced from technical contents of the present invention falls in the protection scope of the present invention without exception.

What is claimed is:

1. A water-saving type household reverse osmosis (RO) membrane assembly, comprising a shell, and at least two RO membrane components; wherein the RO membrane components are used by a way of series connection in a proper order, nesting or a combination of series connection and nesting; in two adjacent RO membrane components, a waste water discharge outlet of one of the RO membrane components connects with a water inlet of another RO membrane component, and clean water discharge outlets for all RO membrane components are connected to a clean water pipe.

2. The water-saving type household reverse osmosis membrane assembly, as recited in claim 1, wherein the RO membrane components are separated by a baffle plate therebetween.

3. The water-saving type household reverse osmosis membrane assembly, as recited in claim 1, wherein the shell comprises a shell cylinder body and a shell end cover.

4. The water-saving type household reverse osmosis membrane assembly, as recited in claim 1, wherein the shell cylinder body and the shell end cover are sealed by a seal ring, bonded by glue or welded ultrasonically.

5. The water-saving type household reverse osmosis membrane assembly, as recited in claim 1, wherein the shell comprises one water inlet, one waste water opening and at least one waste water opening.

6. The water-saving type household reverse osmosis membrane assembly, as recited in claim 1, wherein each of the RO membrane components comprises: an RO membrane layer, wherein the RO membrane layer forms an annular cylinder to filter and divide tap water entering from one end into pure water and waste water for outputting toward the other end; and an intermediate pipe, wherein the intermediate pipe is provided axially in the annular cylinder and has an intermediate passageway internally; the intermediate pipe has a pure water inlet communicating with the intermediate passageway formed on a pipe wall to receive the pure water separated out by the RO membrane layer, and an axial length of the intermediate pipe is greater than that of the RO membrane layer.
